(19) United States
(12) Patent Application Publication
(10) Pub. No.: US 2025/0125717 A1
(43) Pub. Date: Apr. 17, 2025

(54) CAPACITOR PROTECTION IN A POWER CONVERTER

(71) Applicant: Eaton Intelligent Power Limited, Dublin (IE)

(72) Inventors: Mahesh Mysore Swamy, Gurnee, IL (US); Hua Qiang Li, Menomonee Falls, WI (US)

(21) Appl. No.: 18/802,242

(22) Filed: Aug. 13, 2024

Related U.S. Application Data
(60) Provisional application No. 63/544,043, filed on Oct. 13, 2023.

(51) Int. Cl. H02M 1/34; H02M 1/32

(52) U.S. Cl. CPC H02M 1/344; H02M 1/325

(57) ABSTRACT

A system includes: a DC bus electrically configured for connection to one or more of a rectifier and an inverter, the DC bus including a positive bus and a negative bus; and a DC link electrically connected to the DC bus. The DC link includes: an energy storage apparatus includes at least two energy storage elements; and a fuse assembly electrically connected the energy storage apparatus and to one of the positive bus and the negative bus.

### CROSS-REFERENCE TO RELATED APPLICATION

This application claims priority to U.S. Provisional Application No. 63/544,043, filed on Oct. 13, 2023, and titled CAPACITOR PROTECTION IN A POWER CONVERTER, which is incorporated herein by reference in its entirety.

### TECHNICAL FIELD

This disclosure relates to capacitor protection in a power converter.

### BACKGROUND

A power converter, such as a variable speed drive, an adjustable speed drive, or an uninterruptable power supply, may be connected to an alternating current (AC) high-power electrical distribution system, such as a power grid. The power converter may drive, power, and/or control, for example, an electric machine or a power electronic load. The electrical apparatus includes an electrical network that converts AC power to direct-current (DC) power or DC power to AC power.

### SUMMARY

In one aspect, a system includes: a DC bus electrically configured for connection to one or more of a rectifier and an inverter, the DC bus including a positive bus and a negative bus; and a DC link electrically connected to the DC bus. The DC link includes: an energy storage apparatus that includes at least two energy storage elements; and a fuse assembly electrically connected the energy storage apparatus and to one of the positive bus and the negative bus.

Implementations may include one or more of the following features.

The energy storage apparatus may include at least two energy storage elements in series.

The energy storage apparatus may include at least two energy storage elements in parallel. Each energy storage element includes a film capacitor.

The fuse assembly may include a fuse element in parallel with a capacitive element.

The energy storage apparatus may be electrically connected to the positive bus, and the fuse assembly may be electrically connected to the energy storage apparatus and the negative bus.

The energy storage apparatus may be electrically connected to the negative bus, and the fuse assembly may be electrically connected to the energy storage apparatus and the positive bus.

The energy storage apparatus may include two or more strings of capacitors in parallel with each other, and each of the two or more strings of capacitors may include at least two capacitors in series.

The system also may include a discharge circuit. The discharge circuit may include a discharge resistor and a controllable switch, and the controllable switch may be configured to turn ON in response to a short in one of the at least two energy storage elements.

In another aspect, a protection apparatus for a drive system includes: a fuse assembly configured to be electrically connected between (i) a group of capacitors in the drive system and (ii) one of a positive bus and a negative bus of the drive system. The fuse assembly includes: a fuse element in parallel with a capacitive element, the fuse element being configured to open in response to a short circuit in the one of the capacitors in the group of capacitors such that the capacitive element provides an impedance and a current path to another one of the capacitors in the group of capacitors that does not have a short circuit.

In some implementations, the protection apparatus also includes a discharge circuit configured to be electrically connected to the positive bus and the negative bus of the drive system.

In another aspect, a drive apparatus includes: a rectifier; an inverter; and a DC link electrically connected to the rectifier and the inverter. The DC link includes: a positive bus; a negative bus; an energy storage apparatus including at least two groups of capacitors; and a fuse assembly electrically connected to each group of capacitors and to one of the positive bus and the negative bus.

Implementations may include one or more of the following features.

Each group of capacitors may include two capacitors in parallel.

Each group of capacitors may include at least two strings of capacitors, and each string may include at least two capacitors that are electrically in series.

Each fuse assembly may have the same fuse rating.

Each fuse assembly may be connected to one of the group of capacitors and to the positive bus.

Each fuse assembly may be connected to one of the group of capacitors and to the negative bus.

Each group of capacitors may include the same number of capacitors in the same configuration, and each group of capacitors may include the same nominal capacitance.

Implementations of any of the techniques described herein may include an apparatus, a device, a system, and/or a method. The details of one or more implementations are set forth in the accompanying drawings and the description below. Other features will be apparent from the description and drawings, and from the claims.

### DRAWING DESCRIPTION

FIG. 1 is a block diagram of an example of a power converter.

FIG. 2 is a schematic of an example of a system that includes a power converter.

FIG. 3 is a schematic of another example of a system that includes a power converter.

FIG. 4 is a schematic of another example of a system that includes a power converter.

FIGS. 5A-5D show data from a simulation of the power converter of FIG. 4.

FIG. 6 is a schematic of another example of a system that includes a power converter.

FIG. 7 is a schematic of another example of a system that includes a power converter.

FIG. 8 is a schematic of another example of a system that includes a power converter.

FIG. 9 is a schematic of another example of a system that includes a power converter.

FIG. 10 is a schematic of another example of a system that includes a power converter.

### DETAILED DESCRIPTION

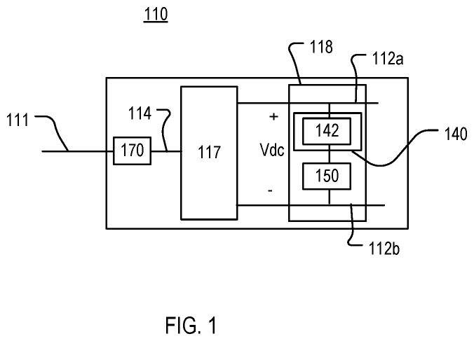

FIG. 1 is a block diagram of an example of a power converter 110. The power converter 110 includes an input node 111, a filter system 170, a rectifier 117, and a DC link 118. In the example shown in FIG. 1, the filter system 170 is between the input node 111 and an intermediate node 114. However, the filter system 170 may be positioned in a different part of the power converter 110 or may be omitted.

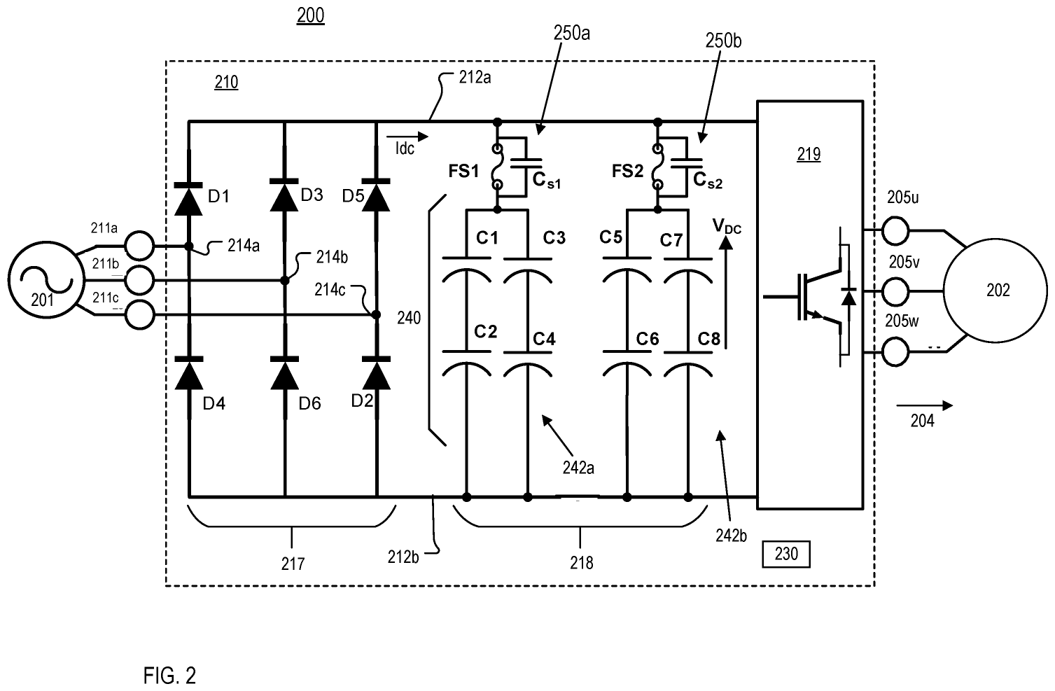

The rectifier 117 includes electronic elements arranged and/or controlled to convert alternating current (AC) or time-varying power from the power distribution network 101 to direct current (DC) power that is provided to the DC link 118. The rectifier 117 is any sort of arrangement of electrical elements that converts AC current to DC current. For example, the rectifier 117 may be a diode bridge rectifier. The power converter 110 may include additional elements and components. For example the power converter 110 may include an inverter such as the inverter 219 (FIG. 2). The power converter 110 may be a drive apparatus. For example, the power converter 110 may be a variable frequency drive (VFD), adjustable speed drive (ASD), or a variable speed drive (VSD).

The DC link 118 includes a positive bus 112a and a negative bus 112b. In operational use of the power converter 110, the voltage across the DC link 118 is Vdc and the positive bus 112a is at a potential that is Vdc volts greater than the negative bus 112b. The DC link 118 also includes an energy storage apparatus 140 that stores electrical potential energy in the form of voltage.

The energy storage apparatus 140 includes one or more groups of capacitors 142. Although the power converter 110 may include more than one group of capacitors 142, only one group of capacitors 142 is shown in FIG. 1. Each group of capacitors 142 may include, for example, two or more capacitors in series, capacitors in parallel with each other, or two or more parallel strings of series capacitors, where each string includes at least two capacitors in series. The capacitors may be electrolytic capacitors and/or film capacitors. A fuse assembly 150 is electrically connected to the group of capacitors 142. The fuse assembly 150 is also electrically connected to the positive bus 112a or the negative bus 112b.

When a capacitor in one of the groups 142 experiences a short circuit, the potential energy stored in the capacitor is released suddenly. This released energy can cause component failure and can ignite items near the power converter 110. For example, the power converter 110 may be required to pass component failure test. As part of the component failure test, the energy storage apparatus 240 is subject to a short and a flammability test is conducted. The flammability test involves wrapping the power converter 110 in a cotton blanket and applying the capacitor short via external stimulus. If the protection for the energy storage apparatus 240 is insufficient, the cotton blanket can catch fire and the converter 110 is said to have failed the component failure test.

Moreover, when one of the capacitors in the group 142 is shorted, another capacitor in the group 142 is suddenly subject to twice the voltage. This causes a high current to flow in the DC link 118 and other components in the power converter 110 and may cause the entire power converter 110 to fail or significantly damaged.

On the other hand, the configuration and placement of the fuse assembly 150 protects the capacitors in the groups of capacitors 142 from being damaged during an event that causes one or more of the capacitors to short. The fuse assembly 150 also helps to effectively manage surge currents that may occur during a brown-in event. Furthermore, the configuration and placement of the fuse assembly 150 also ensures that the power converter 110 is able to comply with component failure tests.

FIG. 2 is a schematic of a system 200. The system 200 includes a power converter 210 that is connected to a load 202 and a three-phase AC electrical power distribution network 201. The power converter 210 may be, for example, a variable speed drive (VSD), an adjustable speed drive (ASD), or a variable frequency drive (VFD). The load 202 may be, for example, an induction motor or a permanent magnet synchronous machine. The dashed lines are used to show groupings of components, and the dashed lines do not necessarily represent physical objects. However, the power converter 210 may be in a housing or enclosure, such as a rack-mountable box or a cabinet.

The electrical power distribution network 201 distributes AC electrical power that has a fundamental frequency of, for example, 50 or 60 Hertz (Hz). The distribution network 201 may include, for example, one or more transmission lines, distribution lines, electrical cables, and/or any other mechanism for transmitting electricity. The distribution network 201 includes three phases, which are referred to as a, b, and c. Each phase a, b, c has a respective grid voltage Va, Vb, Vc. The power converter 210 includes input nodes 211a, 211b, 211c, each of which is electrically coupled to one of the three phases (a, b, c) of the distribution network 201. The power converter 210 also includes intermediate nodes 214a, 214b, 214c.

The power converter 210 also may include a filter system (not shown in FIG. 2). The filter system may be, for example, an inductor or LCL filter between each input node 211a 211b, 211c and respective intermediate node 214a 214b, 214c. Other implementations of the filter system are possible. For example, the filter system may be implemented as a DC link choke between the rectifier 217 and the DC link 218.

The power converter 210 includes a rectifier 217, a DC link 218, and an inverter 219. The rectifier 217 includes electronic switches arranged and/or controllable to convert AC currents ia, ib, ic at the nodes 214a, 214b, 214c into DC current Idc that flows to the DC link 218. In the example of FIG. 2, the rectifier 217 is a diode bridge rectifier that includes diodes D1 to D6. The diode D1 and the diode D4 are electrically connected to the intermediate node 214a, the diode D1 is electrically connected to a positive bus 212a of the DC link 218, and the diode D4 is electrically connected to a negative bus 212b of the DC link 218. The diode D3 and the diode D6 are electrically connected to the intermediate node 214b, the diode D3 is electrically connected to the positive bus 212a, and the diode D6 is electrically connected to the negative bus 212b. The diode D5 and the diode D2 are electrically connected to the intermediate node 214c, the diode D5 is electrically connected to the positive bus 212a, and the diode D2 is electrically connected to the negative bus 212b.

The DC link 218 includes an energy storage apparatus 240. The energy storage apparatus 240 includes sections or groups of capacitors 242a and 242b. Each group 242a and 242b includes two parallel strings of capacitors, with each string including two series capacitors. The group 242a includes a first string with series capacitors C1 and C2 and a second string with series capacitors C3 and C4. The first string and second string are in parallel with each other. The group 242b is identical and includes a third string with series capacitors C5 and C6 and a fourth string with series capacitors C7 and C8. The third and fourth string are in parallel with each other. The groups 242a and 242b have the same number of capacitors in the same arrangement, and the groups 242a and 242b have the same nominal capacitance.

The midpoints of the strings are not electrically connected. For example, the node between the capacitors C1 and C2 is not electrically connected to a node between the capacitors C3 and C4. Moreover, the capacitors C1 to C8 are not individually fused and there are not necessarily fuses in the energy storage apparatus 240 itself.

The group 242a is electrically connected to a fuse assembly 250a and to a negative bus 212b of the DC link 218. As shown in FIG. 2, the capacitors C1 and C3 are directly connected to the fuse assembly 250a. The fuse assembly 250a is also electrically connected to a positive bus 212a of the DC link 218. The group 242b is electrically connected to a fuse assembly 250b and to the negative bus 212b. As shown in FIG. 2, the capacitors C5 and C7 are directly connected to the fuse assembly 250a. The fuse assembly 250b is also electrically connected to the positive bus 212a.

The fuse assembly 250a includes a fuse FS1 and a snubber capacitor Cs1 in parallel with the fuse FS1. The fuse assembly 250b includes a fuse FS2 and a snubber capacitor Cs2 in parallel with the fuse FS2. The fuses FS1 and FS2 are rated to operate at DC voltages that are equal to or greater than Vdc. The current rating of each fuse FS1 and FS2 is at least 15% to 20% greater than the current rating of the capacitors in the respective groups 242a and 242b. Each fuse FS1 and FS2 includes a respective fuse element that opens when a current that generates thermal energy sufficient to melt the fuse element flows through the fuse. The current that opens each fuse FS1 and FS2 depends on the value and duration of the current flowing through the fuse. The parameter that relates to the current that opens each fuse FS1 and FS2 may be referred to as the i2T rating. The i2T rating is captured by the fuse's current versus time curve provided by the fuse manufacturer. When opened, current cannot flow in the fuses FS1 and FS2. When closed, current can flow in the fuses FS1 and FS2.

The inverter 219 converts the DC voltage across the energy storage apparatus 240 into three-phase AC voltage, which is then fed into the load 202. The output voltage level and the output fundamental frequency are controlled by the controller 230, the output of which controls the inverter switches in inverter 219. The inverter 219 includes output terminals 205u, 205v, 205w, each of which is connected to one of the three phases of the load 202. The inverter 219 includes a network of electronic switches (for example, power transistors) that are arranged to generate the desired AC voltage.

The inverter 219 may be controlled based on a pulse width modulation (PWM) control scheme such as, for example, a space vector PWM control scheme. The control for the inverter 219 may be implemented by a control system 230. The control system 230 includes an electronic processor, an electronic storage, and an input/output interface. The control system 230 may be a microcontroller.

The discussion above relates to the power converter generating the AC driver signal 204 and providing the AC driver signal 204 to the load 202. However, other configurations and applications are possible. For example, the power converter 210 may be implemented without the inverter 219 and configured to drive a DC load.

The operation of the power converter 210 during a capacitor shorting event is discussed next, with the capacitor C4 used as an example. Prior to the capacitor shorting event, the power converter 210 operates normally. The DC link 218 is healthy and none of the capacitors C1 to C8 are shorted. The voltage across the DC link 218 is Vdc, and the controller 230 controls the amplitude and frequency of the output voltage being fed into the load 202.

The capacitor shorting event occurs, and the capacitor C4 is shorted. The energy stored in the capacitor C4 is suddenly released and a high current flows from the capacitors C1 and C2 into the capacitor C3 and the shorted capacitor C4. This causes the voltage across the capacitor C3 (which is in series with the shorted capacitor C4) to increase from Vdc/2 to Vdc. Current also rushes in from the rectifier 217 and other adjoining branches (the capacitors C5, C6, C7, C8 in the example of FIG. 2). This high current causes the fuse FS1 to open such that the snubber capacitor Cs1 becomes part of the group 242a.

Once the fuse FS1 opens, the snubber capacitor Cs1 provides a high impedance path, thereby preventing current flow or greatly reducing current flow into the capacitor C3. By reducing or eliminating the current flow into the capacitor C3, the capacitor C3 does not fail and the short circuit current does not ignite items near the power converter 210 (such as the cotton blanket during the flammability test). The power converter 210 is able to continue to operate though with less capacitance. Depending on the load 202, the power converter 210 may trip or may continue to operate. Regardless, the fuse assembly 250a prevents the high current that flows due to the shorting event from igniting components near the power converter 210 (such as the cotton blanket during the flammability test) and/or causing failure of the power converter 210.

The fuses FS1 and FS2 are rated to operate at DC voltages corresponding to Vdc or greater. The current rating of the fuses FS1 and FS2 have a safety margin to accommodate for at least 15% to 25% more than the ripple current rating of the capacitors in the respective groups 242a and 242b. The ripple current rating of the capacitor is calculated based on the required load side reactive current and the supply side reactive current, which in turn depends on whether or not a DC link or input AC reactor is used. Any know approach may be used to determine the ripple current rating.

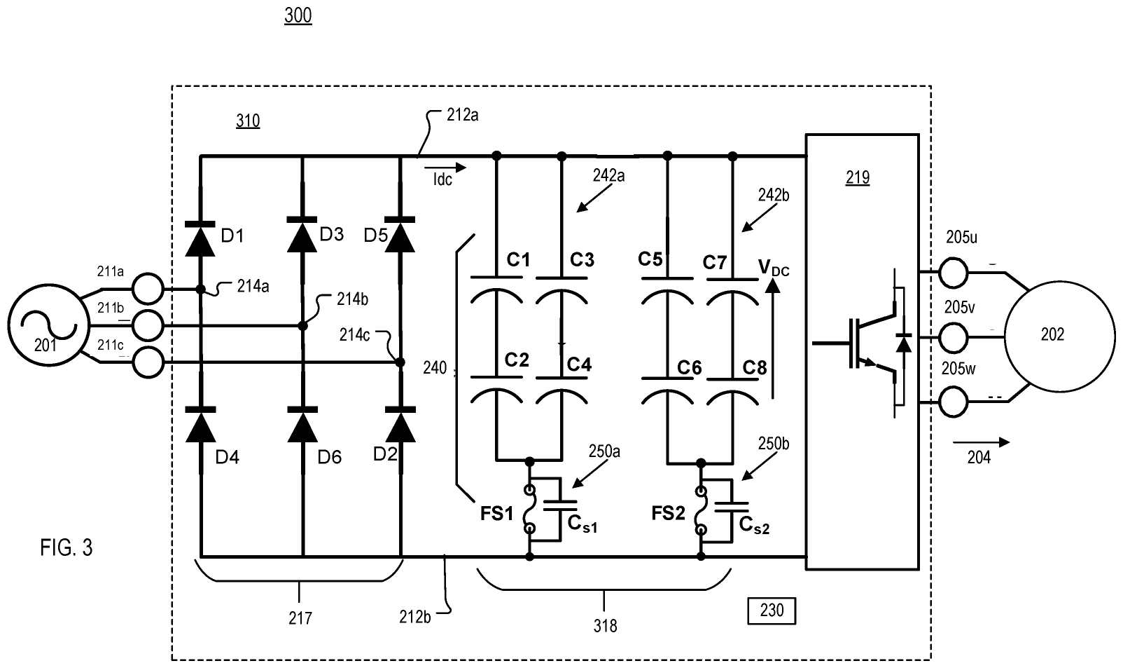

FIG. 3 is a schematic of a system 300 that includes a power converter 310. The power converter 310 is the same as the power converter 210, except the power converter 310 includes a DC link 318 instead of the DC link 318. The DC link 318 is similar to the DC link 218, except in the DC link 318, the fuse assemblies 250a and 250b are electrically connected to the negative bus 212b instead of the positive bus 212a. The group of capacitors 242a is electrically connected to the fuse assembly 250a and to the positive bus 212a. The group of capacitors 242b is electrically connected to the fuse assembly 250b and the positive bus 212a.

The fuse assemblies 250a and 250b in the arrangement shown in FIG. 3 provide the same short circuit protection as they do when placed on the positive bus 212a side (in the arrangement shown in FIG. 2). The fuse assemblies 250a and 250b may be electrically connected to the negative bus 212b, for example, in situations in which disconnecting the positive bus 212a from the energy storage apparatus 240 may be challenging.

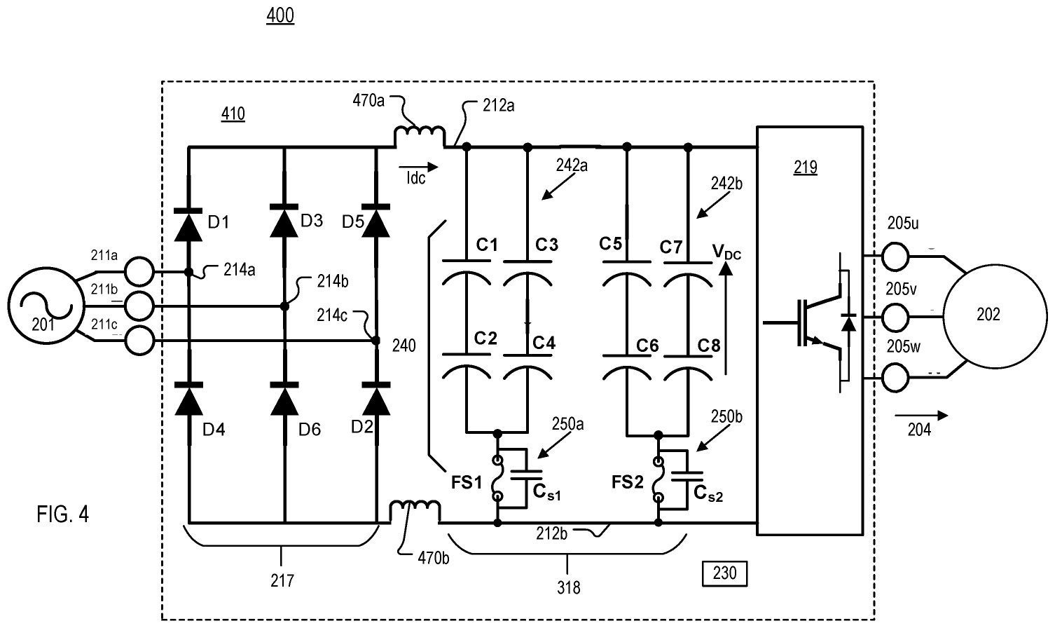

FIG. 4 is a schematic of a system 400 that includes a power converter 410. The power converter 410 is the same as the power converter 310, except the power converter 410 includes DC link choke inductors 470a and 470b. The DC link choke inductor 470a is in the positive bus 212a between the rectifier 217 and the DC link 218. The DC link choke 470b is in the negative bus 212b between the rectifier 217 and the DC link 218.

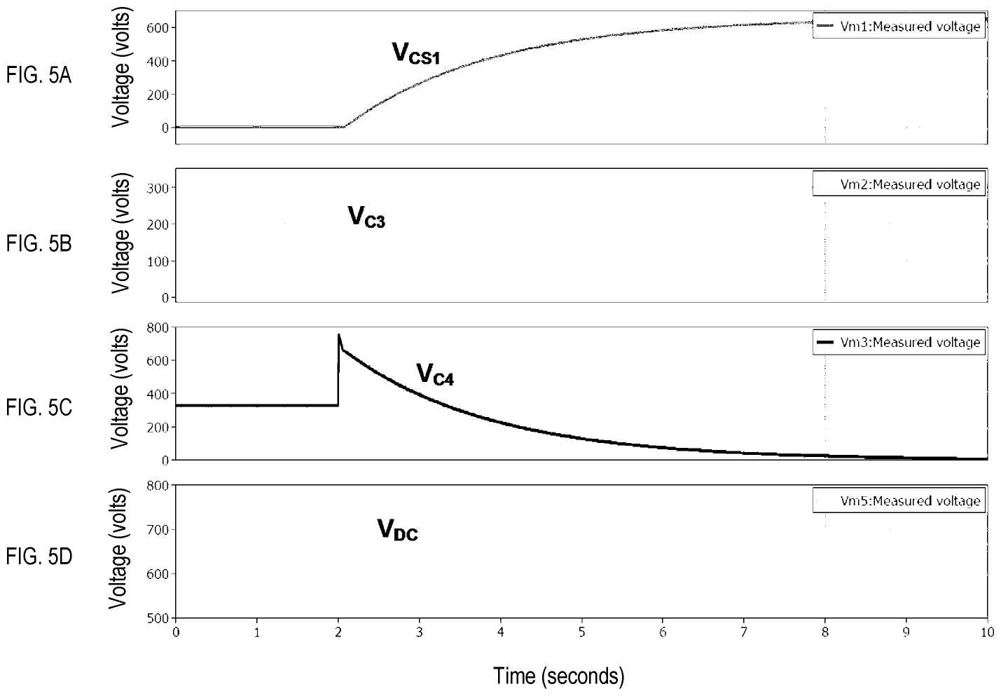

FIGS. 5A-5D show data from a simulation of the power converter 410 (FIG. 4). In the simulation, the input voltage at the nodes 211a, 211b, 211c was 480V AC; the power converter 410 was rated for 480V, 103 amperes (A), and 55 kilowatts (KW); each DC link choke inductor 470a, 470b was 530 microhenries (μH), the DC bus capacitance was 3,600 microfarads (μF), and the capacitance of each capacitor C1 to C8 was 1,800 μF.

FIG. 5A shows the voltage of the snubber capacitor Cs1 as a function of time, FIG. 5B shows the voltage across the capacitor C3 (VC3) as a function of time, FIG. 5C shows the voltage across the capacitor C4 (VC4) as a function of time, and FIG. 5D shows the voltage across the DC bus (Vdc) as a function of time. FIGS. 5A-5D have the same time scale with units of seconds(s).

In the simulation, the power converter 410 was operating in steady state with a load of 0.1 p.u. (per unit). At time t=2s, the capacitor C3 shorted and a high-current flows into the localized short involving the capacitor C3. The voltage across the capacitor C3 (VC3) falls to zero rapidly just after time t=2s, as shown in FIG. 5B. Also at time t=2s, the voltage across the capacitor C4 (VC4) increases from half of the DC bus voltage (Vdc) to the instantaneous DC bus voltage (Vdc) because the capacitor C3 is experiencing a short. The capacitor C4 thus experiences a step change in the voltage across its terminals and a high inrush current ensues.

The inrush current spike into the capacitor C4 is being fed from the adjoining capacitor sections that include the capacitors C1 and C2, and the capacitors C5, C6, C7, and C8. The charging current that flows into the capacitor C4 from the capacitors C1 and C2 returns back into the capacitors C1 and C2 and does not flow through the fuse FS1 and the negative bus 212b. This is because the negative bus 212b does not provide a preferred path for the current that circulates between the capacitors C1, C2, and C4. However, for the current flowing into the capacitor C4 from the capacitors in the group 242b (the capacitors C5 to C8), the return path includes the fuse FS1, the negative bus 212b, and the fuse FS2. The fuses FS1 and FS2 are in series and experience the same high current amplitude. A fault current path exists from the input AC source 201, via the diodes in the rectifier 217, the DC link choke 470a, the shorted capacitor C3, and finally into the capacitor C4. This fault current returns to the source 201 only through the fuse FS1. Hence, the thermal stress on the fuse FS1 is slightly higher than that on the fuse FS2 and the fuse FS1 is likely to open before the fuse FS2.

After the i2T rating of the fuse FS1 is reached, the fuse FS1 opens, bringing the snubber capacitor CS1 into the capacitor group 242a. The snubber capacitor CS1 forms a high impedance path between the capacitor bank formed by the group 242a (capacitors C1, C2, C3, C4)—and the negative bus 212b. Shortly after time t=2s, the voltage across the capacitor C4 (VC4) starts to partially circulate and dissipate in the minor loop formed between itself and C1-C2 branch. The source 201 also provides charging energy to snubber capacitor CS1, through C1 and C2. The voltage across CS1 (VCS1) starts to increase, as seen in FIG. 5A. As shown in FIG. 5C, the capacitor C4 experienced a high voltage condition for at least 0.5 seconds right around time t=2s. The overvoltage rating of the capacitor C4 allows the capacitor C4 to withstand the higher voltage for this relatively short amount of time without destruction.

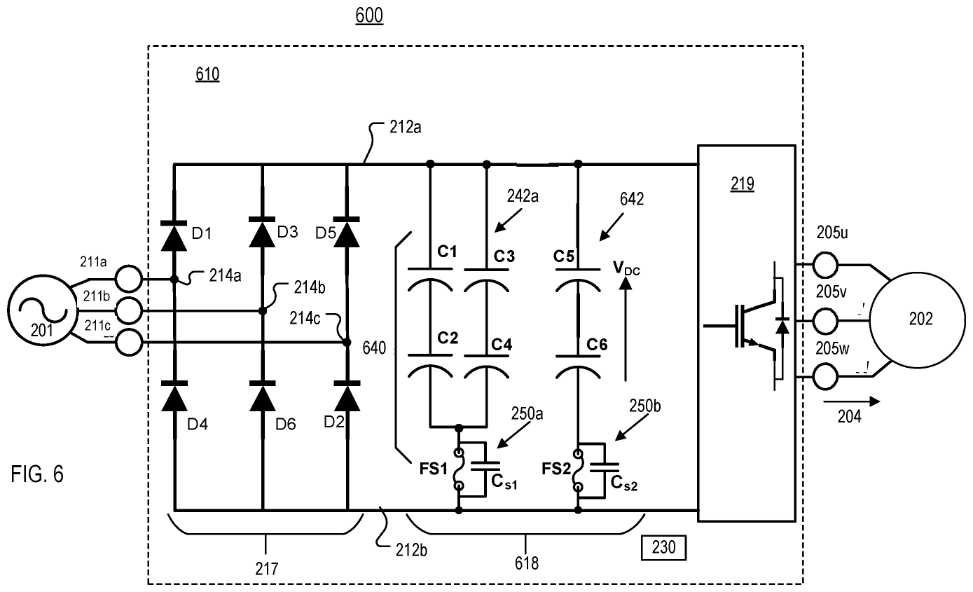

FIG. 6 is a schematic of a system 600. The system 600 includes a power converter 610. The power converter 610 is similar to the power converter 310 except the power converter 610 includes a DC link 618. The DC link 618 is similar to the DC link 318, except the DC link 618 includes a group of capacitors 642 instead of the group 242b. The group of capacitors 642 is a single string of two capacitors in series: the capacitors C5 and C6. Thus, the power converter 610 includes an odd number of capacitor strings or branches. Specifically, the power converter 610 includes three capacitor branches, two in the group 242a and one in the group 642.

The group 242a is electrically connected to the fuse assembly 250a and to the positive bus 212a. The fuse assembly 250a is electrically connected to the negative bus 212b. The group 642 is electrically connected to the fuse assembly 250b and to the positive bus 212a. The fuse assembly 250b is electrically connected to the negative bus 212b.

Though the fuse FS2 can be of lower value since it supports only one capacitor branch, the fuse rating of the fuses FS2 and FS1 should be the same. Moreover, the fuse rating of the fuses FS1 and FS2 is sufficient to protect the respective group 242a and 642. When a capacitor in the group 242a (for example, the capacitor C4) shorts, short circuit current circulates in the minor loop formed by the other capacitors in the group 242a (the capacitors C1, C2, and C3). The non-shorted capacitor C3 connected to C4 experiences a high voltage, and charging current flows from the capacitors C1 and C2 into the capacitor C3. Short circuit current also flows from the adjoining group 642 and from the source 201. The fuse FS1, which is in series with group 242a, eventually opens and the snubber capacitor Cs1 is charged. The charged snubber capacitors provides high impedance thereby arresting the current in the shorted branch.

If a capacitor in the group 642 shorts, a similar sequence of events occur and a short circuit current will flow through the fuse FS2. This short circuit current causes the fuse FS2 to open and puts the snubber capacitor Cs2 into the group 642. The snubber capacitor Cs2 provides a high impedance path and prevents or reduces the short circuit current in the shorted capacitor.

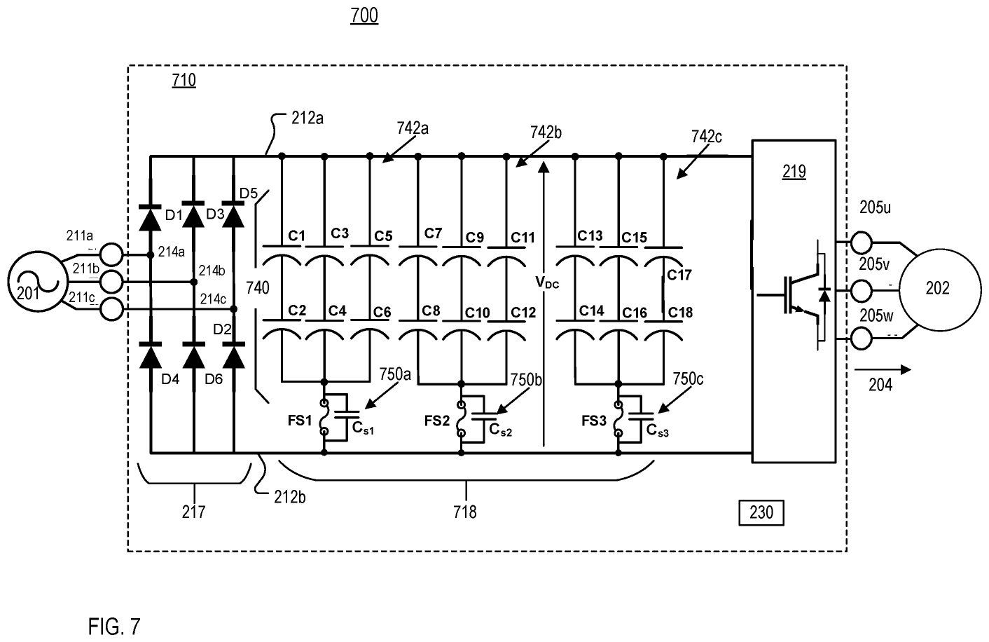

FIG. 7 is a schematic of a system 700 that includes a power converter 710. The power converter 710 is the same as the power converter 310 except the power converter 710 includes a DC link 718 instead of the DC link 318. The DC link 718 is similar to the DC link 318, but the DC link 718 includes three groups of capacitors 742a, 742b, 742c. Each group 742a, 742b, 742c includes three parallel strings of capacitors, with each string including two series capacitors. The group 742a includes a first string of series capacitors C1 and C2, a second string of series capacitors C3 and C4, and a third string of series capacitors C5 and C6. The group 742b includes a first string of series capacitors C7 and C8, a second string of series capacitors C9 and C10, and a third string of series capacitors C11 and C12. The group 742c includes a first string of series capacitors C13 and C14, a second string of series capacitors C15 and C16, and a third string of series capacitors C17 and C18.

Each group 742a, 742b, 742c is electrically connected to the positive bus 212a and to a respective fuse assembly 750a, 750b, 750c. The fuse assemblies 750a, 750b, 750c are electrically connected to the negative bus 212b. Each fuse assembly 750a, 750b, 750c includes a respective fuse FS1, FS2, FS3 in parallel with a respective snubber capacitor Cs1, Cs2, Cs3.

A short circuit event in one of the groups 742a, 742b, 742c causes the fuse of the respective fuse assembly 750a, 750b, 750c to open such that the respective snubber capacitor Cs1, Cs2, Cs3 provides a high-impedance path to the affected string. For example, if the capacitor C18 experiences a short circuit event, short circuit current flows into the capacitor C18 and returns via the fuse FS3. When the fuse FS3 opens, the snubber capacitor Cs3 provides a high impedance path to the capacitor C17.

The configuration of the power converter 710 shown in FIG. 7 is an example and other configurations are possible. For example, the fuse assemblies 750a, 750b, and 750c may be electrically connected to the positive bus 212a instead of the negative bus 212b. Moreover, the power converter 710 may be implemented with a filter such as the DC link choke inductors 470a and 470b and/or a filter between the intermediate nodes 214a, 214b, 214c and the input nodes 211, 211b, 211c. In another example, the power converter 710 may include more or fewer than three capacitor groups, with each group having a respective fuse assembly.

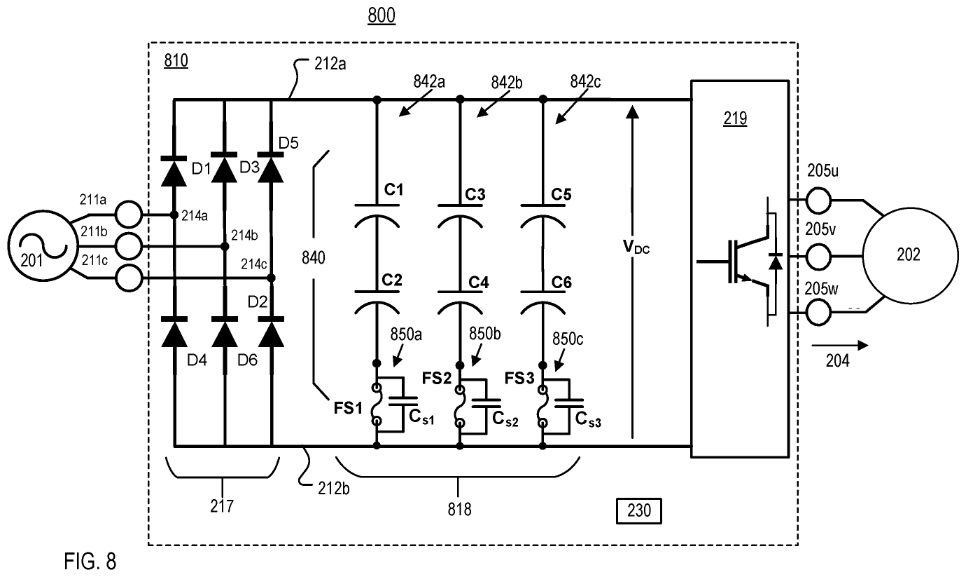

FIG. 8 is a schematic of a system 800 that includes a power converter 810. The power converter 810 includes three groups of capacitors 842a, 842b, 842c. Each group 842a, 842b, 842c includes one string of capacitors, with each string having two capacitors in series. The group 842a includes series capacitors C1 and C2, the group 842b includes series capacitors C3 and C4, and the group 842c includes series capacitors C5 and C6.

The group 842a is electrically connected to a fuse assembly 850a and to the positive bus 212a, the group 842b is electrically connected to a fuse assembly 850b and to the positive bus 212a, and the group 842c is electrically connected to a fuse assembly 850b and to the positive bus 212a. The fuse assemblies 850a, 850b, and 850c are electrically connected to the negative bus 212b. Each fuse assembly 850, 850b, 850c includes a respective fuse FS1, FS2, FS3 in parallel with a respective snubber capacitor Cs1, Cs2, Cs3. The fuses FS1, FS2, FS3 have the same i2T rating and the snubber capacitors Cs1, Cs2, Cs3 have the same capacitance.

The configuration of the power converter 810 shown in FIG. 8 is an example and other configurations are possible. For example, the fuse assemblies 850a, 850b, and 850c may be electrically connected to the positive bus 212a instead of the negative bus 212b. Moreover, the power converter 810 may be implemented with a filter such as the DC link choke inductors 470a and 470b and/or a filter between the intermediate nodes 214a, 214b, 214c and the input nodes 211, 211b, 211c. The power converter 810 may include more or fewer than three groups of series capacitors, with each group having a respective fuse assembly.

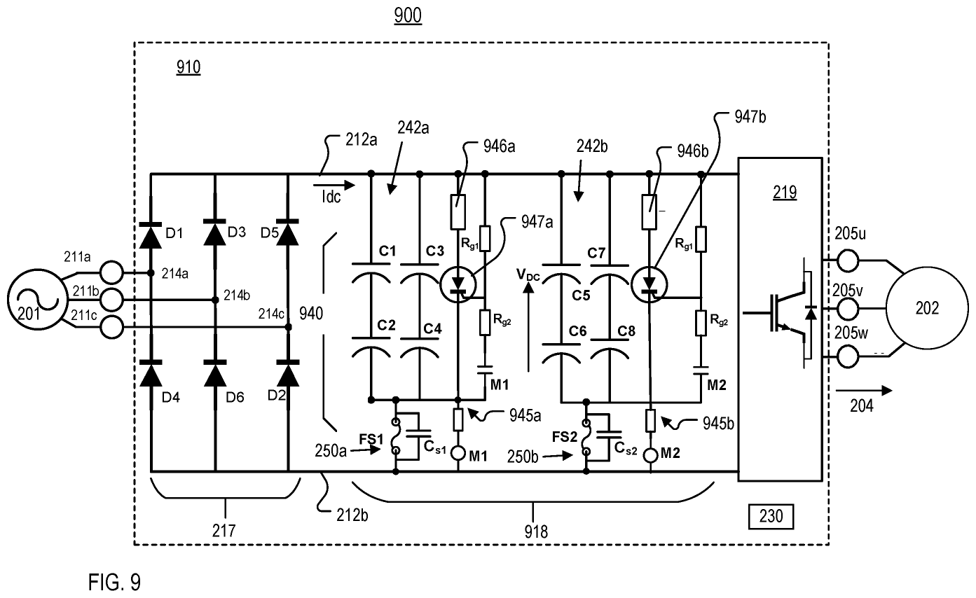

FIG. 9 is a schematic of a system 900 that includes a power converter 910. The power converter 910 is the same as the power converter 310 (FIG. 3), except the power converter 910 includes a DC link 918. The DC link 918 includes the groups of capacitors 242a and 242b and the fuse assemblies 250a and 250b but also includes discharge charge circuits 945a and 945b. The discharge circuits 945a and 945b help to discharge the capacitor that is in series with a shorted capacitor more quickly. Increasing the discharge speed reduces the amount of time that the surviving capacitor is exposed to high voltage and also allows the snubber capacitor in the fuse assembly associated with the shorted capacitor to charge more quickly.

The discharge circuit 945a includes a discharge resistor 946a and a controllable switch 947a that is electrically connected to the discharge resistor 946a. The discharge resistor 946a is electrically connected to the positive bus 212a. The controllable switch 947a may be, for example, a silicon controlled rectifier (SCR). The controllable switch 947a includes a control node (the gate of the SCR) that is electrically connected to a voltage divider. The control node is used to control the state of the switch 947a. The controllable switch 947a is electrically connected to a relay coil M1, and the relay coil M1 is electrically connected to the negative bus 212b.

The discharge circuit 945b is configured in the same manner. The discharge circuit 945b includes a discharge resistor 946b and a controllable switch 947b that is electrically connected to the discharge resistor 946b. The discharge resistor 946b is electrically connected to the positive bus 212a. The controllable switch 947b may be, for example, an SCR. The controllable switch 947b includes a control node (the gate of the SCR) that is electrically connected to a voltage divider. The controllable switch 947b is electrically connected to a relay coil M2, and the relay coil M2 is electrically connected to the negative bus 212b.

An example of the operation of the power converter 910 is discussed with respect to a scenario in which the capacitor C2 is shorted. After the capacitor C2 is shorted, the voltage on the capacitor C1 (which is electrically in series with the capacitor C1) increases from half of the DC bus voltage to the full DC bus voltage (Vdc). The fuse FS1 opens shortly after the shorting event occurs. After the fuse FS1 opens, the voltage across the snubber capacitor Cs1 starts to increase and the voltage across the capacitor C1 begins to decrease from Vdc. The discharge circuit 945a helps to rapidly discharge the surviving capacitor (the capacitor C1 in this example) rapidly and promotes rapid charging of the snubber capacitor Cs1.

During steady state operation of the power converter 910, the voltage across the relay coils M1 and M2 is zero and the SCR 947a and 947b are in the OFF state. Continuing the example above, when the capacitor C2 is shorted, the voltage across the snubber capacitor Cs1 starts to increase. When the voltage across the snubber capacitor Cs1 is such that the relay M1 turns ON, the SCR 947a also turns ON and allows fast bleeding of the capacitor C1. The operation of the SCR 947a is localized to the shorted branch (the group 242a in this example) and does not influence the operation of the adjoining capacitor branches (the group 242b in this example). The capacitance of the DC bus is reduced but the power converter 910 can continue to operate so long as the ripple due to the reduced DC bus capacitance does not initiate a drive fault.

A discharge circuit having the configuration of the discharge circuit 945a may be used with any of the DC links and power converters discussed above. For example, the DC link 218 (FIG. 2) may include two instances of the discharge circuit 945a, with one of the instances being associated with the group of capacitors 242a and the other instance being associated with the group of capacitors 242b.

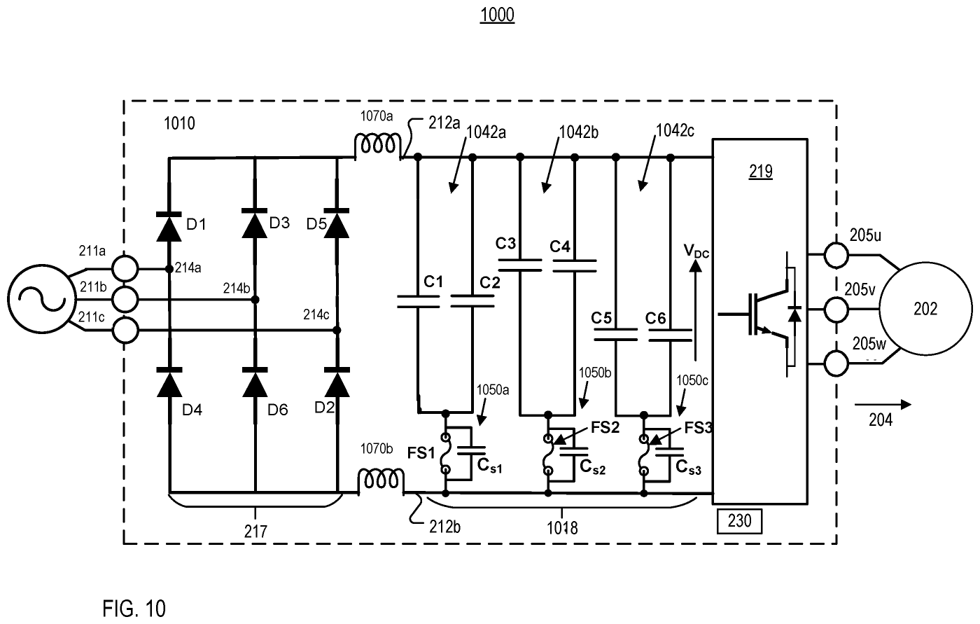

FIG. 10 is a schematic of a system 1000 that includes a power converter 1010. The power converter 1010 includes a DC link 1018 that includes capacitor groups 1042a, 1042b, 1042c, each of which includes two capacitors in parallel. The group 1042a includes parallel capacitors C1 and C2. The group 1042b includes parallel capacitors C3 and C4. The group 1042c includes parallel capacitors C5 and C6. The capacitors C1 and C6 may be film capacitors. Each capacitor group 1042a, 1042b, 1042c is electrically connected to the positive bus 212a and to a respective fuse assembly 1050a, 1050b, 1050c. The fuse assemblies 1050a, 1050b, 1050c are electrically connected to the negative bus 212b. Each fuse assembly 1050a, 1050b, 1050c includes a respective fuse FS1, FS2, FS2 in parallel with a respective snubber capacitor Cs1, Cs2, Cs3.

An example of a short circuit event in the DC link 1018 is provided using a short circuit event in the capacitor C1. The capacitor C1 shorts, and the fuse FS1 opens almost immediately and before FS2 or FS2. By opening FS1, the snubber capacitor Cs1 is placed in series with the capacitor C2, reducing the amount of voltage that is across the capacitor C2 and avoiding failure of the DC link 1018 and/or power converter 1010.

The power converter 1010 is shown as an example, and other implementations are possible. For example, the DC link 1018 may include more or fewer than three capacitor groups and associated fuse assemblies.

These and other implementations are within the scope of the claims.

What is claimed is:

1. A system comprising:
a DC bus electrically configured for connection to one or more of a rectifier and an inverter, the DC bus comprising a positive bus and a negative bus; and
a DC link electrically connected to the DC bus, the DC link comprising:
an energy storage apparatus comprising at least two energy storage elements; and
a fuse assembly electrically connected the energy storage apparatus and to one of the positive bus and the negative bus.

2. The system of claim 1, wherein the energy storage apparatus comprises at least two energy storage elements in series.

3. The system of claim 1, wherein the energy storage apparatus comprises at least two energy storage elements in parallel.

4. The system of claim 3, wherein each energy storage element comprises a film capacitor.

5. The system of claim 1, wherein the fuse assembly comprises a fuse element in parallel with a capacitive element.

6. The system of claim 1, wherein the energy storage apparatus is electrically connected to the positive bus, and the fuse assembly is electrically connected to the energy storage apparatus and the negative bus.

7. The system of claim 1, wherein the energy storage apparatus is electrically connected to the negative bus, and the fuse assembly is electrically connected to the energy storage apparatus and the positive bus.

8. The system of claim 1, wherein the energy storage apparatus comprises two or more strings of capacitors in parallel with each other.

9. The system of claim 8, wherein each of the two or more strings of capacitors comprises at least two capacitors in series.

10. The system of claim 1, further comprising a discharge circuit.

11. The system of claim 10, wherein the discharge circuit comprises a discharge resistor and a controllable switch, and wherein the controllable switch is configured to turn ON in response to a short in one of the at least two energy storage elements.

12. A protection apparatus for a drive system, the protection apparatus comprising:
a fuse assembly configured to be electrically connected between (i) a group of capacitors in the drive system and (ii) one of a positive bus and a negative bus of the drive system, and wherein:
the fuse assembly comprises: a fuse element in parallel with a capacitive element, the fuse element being configured to open in response to a short circuit in the one of the capacitors in the group of capacitors such that the capacitive element provides an impedance and a current path to another one of the capacitors in the group of capacitors that does not have a short circuit.

13. The protection apparatus of claim 12, further comprising a discharge circuit configured to be electrically connected to the positive bus and the negative bus of the drive system.

14. A drive apparatus comprising:
a rectifier;
an inverter; and
a DC link electrically connected to the rectifier and the inverter, the DC link comprising:
a positive bus;
a negative bus;
an energy storage apparatus comprising at least two groups of capacitors; and
a fuse assembly electrically connected to each group of capacitors and to one of the positive bus and the negative bus.

15. The drive apparatus of claim 14, wherein each group of capacitors comprises two capacitors in parallel.

16. The drive apparatus of claim 14, wherein each group of capacitors comprises at least two strings of capacitors, and each string comprises at least two capacitors that are electrically in series.

17. The drive apparatus of claim 14, wherein each fuse assembly has the same fuse rating.

18. The drive apparatus of claim 14, wherein each fuse assembly is connected to one of the group of capacitors and to the positive bus.

19. The drive apparatus of claim 14, wherein each fuse assembly is connected to one of the group of capacitors and to the negative bus.

20. The drive apparatus of claim 14, wherein each group of capacitors comprises the same number of capacitors in the same configuration, and each group of capacitors comprises the same nominal capacitance.
